(19) United States
(12) Patent Application Publication
(10) Pub. No.: US 2005/0037806 A1
(43) Pub. Date: Feb. 17, 2005

(54) Managing an address book in portable terminal having a camera

(76) Inventor: Kyoung-Weon Na, Seoul (KR)

Correspondence Address: Robert E. Bushnell;Suite 300, 1522 K Street, N.W., Washington, DC, 20005, US

(21) Appl. No.: 10/769,882

(22) Filed: Feb. 3, 2004

(30) Foreign Application Priority Data
Aug. 12, 2003 (KR) 2003-55867

(51) Int. Cl. H04M 1/00; H04M 3/00

(52) U.S. Cl. 455/556.1; 348/211.1; 379/355.02

(57) ABSTRACT

An apparatus for managing an address book in a portable terminal includes: a camera section adapted to photograph a text to output a text image signal; an image processing section adapted to convert a text image signal into a digital image data; a text conversion section adapted to convert digital image data into text data with a text recognition program; and a control section adapted to store private information text data of the converted text data in a corresponding item of the address book when one or more items of the address book include an item coinciding with an item of text data converted by the text conversion section.

### CLAIM OF PRIORITY

This application claims priority under 35 U.S.C. § 119 on an application entitled APPARATUS AND METHOD FOR MANAGING ADDRESS BOOK IN PORTABLE TERMINAL HAVING CAMERA filed in the Korean Intellectual Property Office on Aug. 12, 2003 and assigned Serial No. 2003-55867, the contents of which are hereby incorporated by reference.

### BACKGROUND OF THE INVENTION

1. Field of the Invention

The present invention relates to managing private information in a phone book of a portable terminal, and more particularly to an apparatus and a method for reading out text information from a predetermined medium with a camera in a portable terminal, registering and storing data in an address book, or managing data.

2. Description of the Related Art

Generally, a portable terminal has an address book in which names and telephone numbers corresponding to the names are registered, enabling the telephone numbers to be found when a user wants a predetermined telephone number. In earlier disadvantageous arrangements, in order to store a new telephone number in an address book, a portable terminal user must directly input a name and the telephone number to be stored in the portable terminal by using a key input section. However, since the portable terminal typically has a restricted number of keys, the user must combine or repeatedly input several keys in order to store the new telephone number in the address book. Further, a recent portable terminal provides an address book having an expanded function in which not only a telephone number but also various information such as an address and an e-mail address can be stored. Accordingly, in order to register these various kinds of information, much effort and time is required for managing information, e.g.—registration, modification, and deletion of data.

Meanwhile, a business card reading apparatus for reading out text information, such as a name and a telephone number written on a business card, has been recently developed. Further, a business card reading apparatus, which has an interface between a computer or a portable terminal and the business card reading apparatus and provides text information such as a name and a telephone number read out from a business card to the computer or the portable terminal through the interface, has been also developed. However, although these business card reading apparatuses have an advantage in that they reduces a user's inconvenience, that is, the user must input data to a portable terminal by using a key input section, the user must defray much more expense because he must further purchase the business card reading apparatus separately from the portable terminal. Accordingly, a technology is required which can register the text information written on the business card in an address book of the portable terminal and manage the registered information without increasing the cost burden of the user.

The following patents each discloses features in common with the present invention but do not teach or suggest the inventive features specifically recited in the present application: U.S. Patent Publication No. 2002/0167687 to Tsai, entitled METHOD AND APPARATUS FOR LINKING DESIGNATED PORTIONS OF A RECEIVED DOCUMENT IMAGE WITH AN ELECTRONIC ADDRESS, published on Nov. 14, 2002; U.S. Pat. No. 6,650,761 to Rodriguez et al., entitled WATERMARKED BUSINESS CARDS AND METHODS, issued on Nov. 18, 2003; U.S. Pat. No. 6,202,060 to Tran, entitled DATA MANAGEMENT SYSTEM, issued on Mar. 13, 2001; U.S. Pat. No. 5,392,447 to Schlack et al., entitled IMAGE-BASED ELECTRONIC POCKET ORGANIZER WITH INTEGRAL SCANNING UNIT, issued on Feb. 21, 1995; U.S. Pat. No. 6,157,935 to Tran et al., entitled REMOTE DATA ACCESS AND MANAGEMENT SYSTEM, issued on Dec. 5, 2000; and U.S. Pat. No. 6,532,035 to Saari et al., entitled METHOD AND APPARATUS FOR IMPLEMENTATION OF CLOSE-UP IMAGING CAPABILITY IN A MOBILE IMAGING SYSTEM, issued on Mar. 11, 2003.

### SUMMARY OF THE INVENTION

Accordingly, the present invention has been made to solve the above-mentioned problems occurring in the prior art, and an object of the present invention is to provide an apparatus and a method for registering and managing private information such as a telephone number by means of a camera provided in a portable terminal.

Another object of the present invention is to provide an apparatus and a method for automatically registering data written on a business card in an address book by means of a camera provided in a portable terminal, and managing the data.

In order to accomplish the aforementioned objects, according to one aspect of the present, there is provided an apparatus comprising: an address book contained in a portable terminal, the address book adapted to store private information classified into one or more items in the address book; a camera section adapted to photograph a text and to output a text image signal corresponding thereto; an image processing section adapted to convert the text image signal into digital image data;

a text conversion section adapted to convert the digital image data into text data with a text recognition program; and a control section adapted to store private information text data of the converted text data in a corresponding item of the address book, when said one or more items of the address book includes one item coinciding with an item of text data converted by the text conversion section. The control section can be further adapted to search the private information from the address book to enable a user of the portable terminal to communicate with a corresponding individual having the private information.

In order to accomplish the aforementioned objects, according to one aspect of the present, there is provided a method of managing an address book contained in a portable terminal, the method comprising: arranging a camera and the address book in the portable terminal, the address book adapted to store private information classified into one or more items in the address book; determining whether or not the portable terminal is in an image recognition address book registration mode; commanding the camera to obtain an image including at least one line of text in when the portable terminal is in the image recognition address book registration mode; converting the obtained image into text data and repeatedly classifying the text data according to items until a text data conversion of all lines has been completed; and storing the text data classified according to the items in the address book. The method can further comprise searching the private information from the address book to enable a user of the portable terminal to communicate with a corresponding individual having the private information.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram schematically showing a construction of a portable terminal having an address book management apparatus according to an exemplary embodiment of the present invention;

FIG. 2 is a flowchart for explaining a business card reading and storage method according to a first exemplary embodiment of the present invention;

FIG. 3 is a flowchart for explaining a business card reading and storage method according to a second exemplary embodiment of the present invention;

FIG. 4 is a flowchart for explaining a business card reading and storage method according to a third exemplary embodiment of the present invention;

FIG. 5 is a flowchart for explaining a business card reading and storage method according to a fourth exemplary embodiment of the present invention; and

FIG. 6 is a flowchart for explaining a business card reading and storage method according to a fifth exemplary embodiment of the present invention.

### DETAILED DESCRIPTION

Hereinafter, an exemplary embodiment of the present invention will be described with reference to the accompanying drawings. The same reference numerals are used to designate the same elements as those shown in other drawings. In the following description of the present invention, a detailed description of known functions and configuration incorporated herein will be omitted when it may make the subject matter of the present invention rather unclear.

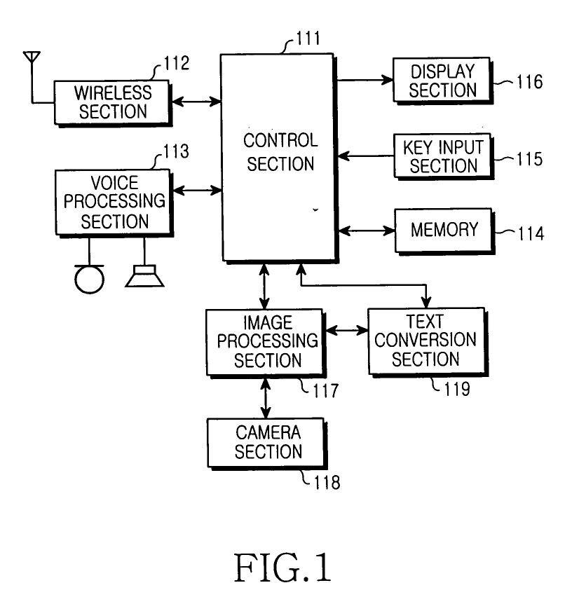

FIG. 1 is a block diagram schematically showing a construction of a portable terminal having an address book management apparatus according to an exemplary embodiment of the present invention. Hereinafter, a construction and an operation of a portable terminal related to the present invention will be described in detail with reference to FIG. 1.

A control section 111 controls a general operation of the portable terminal. Especially, in relation to the present invention, the control section 111 controls a series of processes through which private information is registered in an address book by means of a camera in the portable terminal, and the processes will be described in detail with reference to the flowcharts described below. Further, the control section 111 controls the operation of the portable terminal so that a portable terminal user searches data regarding the private information registered in the address book and communicates with a corresponding individual by using the searched data.

For the sake of simplicity, it is assumed that the private information stored in the address book is text information such as a name, an address, a telephone number, and an e-mail address written on the business card. However, only some information is written on the business card or information may further include other text information such as a home page address. Further, the present invention can be applied to any kind of media in which the text information such as the name and the telephone number is written, in addition to the business card.

A wireless section 112 converts a wireless signal received in an antenna into a predetermined signal by a control of the control section 111 so as to transmit the converted signal to the control section 111 or a voice processing section 113 described below. Further, the wireless section 112 converts a coded signal received in the voice processing section 113 into a signal of a frequency band for transmission of a wireless signal and then outputs the converted signal to the antenna. Signals outputted to the control section 111 from the wireless section 112 are a pilot signal of a base station, a paging signal, data received when data communication is performed, or a message received in the portable terminal from the base station for a power control. Further, in a call set-up, a power control, or a data transmission, the control section 111 transmits data required to be transmitted to the wireless section 112, thereby enabling the wireless section 112 to send the data to the base station. Accordingly, a signal outputted to the voice processing section 113 from the wireless section 112 is a coded voice signal received after the call set-up has been performed.

The voice processing section 113 decodes a signal, which is received in the wireless section 112, by the control of the control section 111 and converts the decoded signal into an electrical voice signal, so as to output the voice signal to a speaker. Further, the voice processing section 113 codes an electrical voice signal, which is received in a microphone, by the control of the control section 111 so as to transmit the coded signal to the wireless section 112.

A camera section 118 takes a photograph of media including texts such as a business card or other printed matter, that is, all objects in which text type information visibly appears, so that they can be photographed by a camera. The camera section 118 has a camera sensor for converting the photographed optical signal into an analog image signal. Further, a charge coupled device (hereinafter, referred to as a CCD) sensor or a complementary metal oxide semiconductor (CMOS) sensor may be used as the camera sensor, and it is assumed that the CCD sensor is used in the exemplary embodiments of the present invention.

A memory 114 includes a read-only memory (hereinafter, referred to as a ROM) and a random access memory (hereinafter, referred to as an RAM). The ROM stores a control program for performing various control functions and data required for control. The control program includes a text recognition program for converting the image signal into text data. In the present invention, it is assumed that the text recognition program uses a typical optical character reader (OCR) software. Further, the ROM has an area for storing a text database and an item database used in the text recognition program. The RAM temporarily stores data generated when the control of the control section 111 is performed, image data obtained by converting a text image signal acquired through the camera section 118 into a digital type, and text data recognized from the image data.

The memory 114 has a memory area for registering the text data, for instance, private information read out from a business card. The private information mentioned in the present invention means all information related to some individual, organization, or enterprise which can be collected and made into data. Hereinafter, the memory area is called an address book table. Table 1 shows an example in which the data are stored in the address book table.

TABLE 1

| Ad- | | Telephone | Cell phone | |
|---|---|---|---|---|
| dress | Name | number | number | E-mail address |
| 00 | Hong gil | 031-123-4567 | 011-123-4567 | hong@yahoo.com |
| | dong | | | |
| 01 | Intellectual | 042-234-5687 | 016-123-4567 | patent@kipo.gov |
| | Property | | | |
| | Office | | | |
| — | — | — | — | — |

In the description of the present embodiment, an assumption has been made that the address book table has four items, that is, a name, a telephone number, a cell phone number, and an e-mail address, but the number, names, and kinds of items can be modified.

An image processing section 117 converts the analog image signal outputted from the camera section 118 into digital image data by the control of the control section 111. Further, the image processing section 117 compresses or expands the digital image data and generates screen data for display.

A text conversion section 119 converts the digital image data provided from the image processing section 117 into the text data by means of the text recognition program under the control of the control section 111. Further, the text conversion section 119 stores the text data converted under the control of the control section 111 in the address book table of the memory 114.

A display section 116 displays the screen data for display outputted from the image processing section 117 on a screen, and displays user data outputted from the control section 111.

A key input section 115 has a key matrix structure and includes numeral keys for dialing and function keys for performing various functions. The key input section 115 generates a key signal corresponding to a key operated by a user so as to provide the generated key signal to the control section 111. Further, the key input section 115 includes separate function keys or multi-function keys for performing a business card or an image recognition and an address book registration according to the present invention.

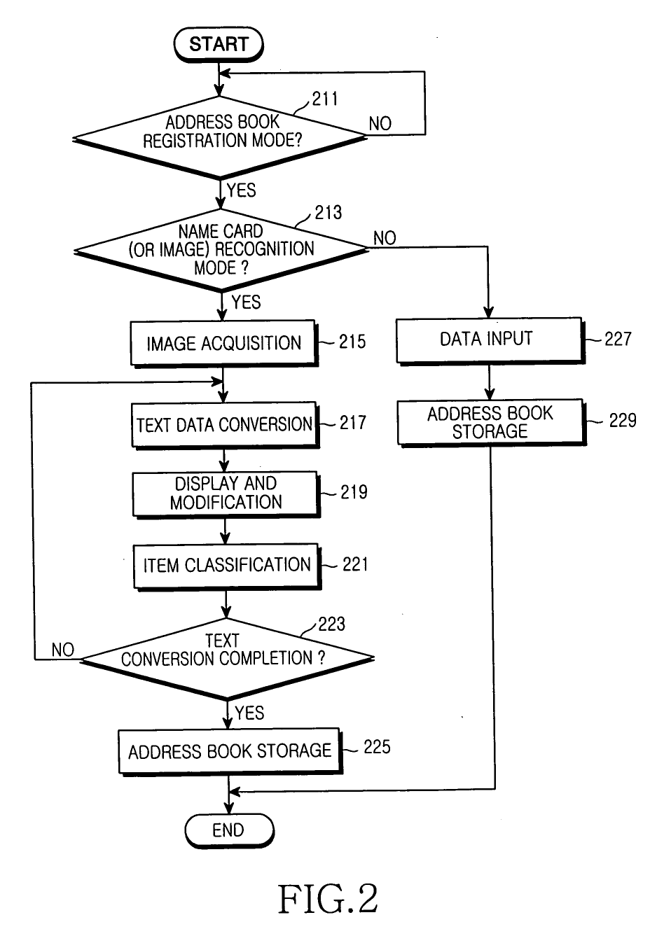

FIG. 2 is a flowchart illustrating a method for registering data in an address book by means of a camera according to a first exemplary embodiment of the present invention. Hereinafter, a method for registering data, which are written on a business card, in an address book by means of a camera will be described in detail with reference to FIG. 2.

In step 211, the control section 111 examines whether or not a function key for an address book registration of the key input section 115 has been inputted by a key operation of a user. From the result of the examination, when it is determined that the function key for the address book registration has been inputted, step 213 is performed. In contrast, when there is no key input, the control section 111 waits for the key input in an initial state. In step 213, the control section 111 examines whether or not a function key for a business card or an image recognition has been inputted. The function key for the business card or the image recognition is used for setting a mode in which text information is photographed from a predetermined medium by means of a camera and the photographed text information is read out. Herein, the function key for the business card or the image recognition may be assigned to a key separate from the function key for the address book registration, or it is assigned to an identical key and may be classified according to the number of times of an input. Meanwhile, as described above, the present invention can be applied to other media including texts (e.g. a book, a poster, or an advertising bill), besides the business card. However, for convenience of description, the present invention will be described on an assumption that a case in which the business card is recognized is employed as one detailed embodiment of the image recognition.

When it is determined that the function key for the business card recognition has been inputted in step 213, step 215 is performed. In contrast, when the function key for the business card recognition is not inputted, step 227 is performed. In step 227, the control section 111 directly receives data from a user through the key input section 115 according to items on the basis of a typical address book registration procedure, and stores the data in the address book table according to the items in step 229.

Meanwhile, in step 215, the control section 111 controls the camera section 118 and the image processing section 117 to obtain an image of the business card which is desired to be registered in the address book. That is, the control section 111 drives the camera section 118 to photograph the business card which is desired to be registered in the address book. The analog image signal photographed by the camera section 118 is inputted to the image processing section 117. The image processing section 117 converts the analog image signal outputted from the camera section 118 into digital data by means of an analog to digital converter (ADC), and then outputs the converted data. The digital image data are compressed so as to be easily stored in the memory, and then temporarily stored in the memory 114 as temporary image data.

After obtaining the image of the business card, in step 217, the control section 111 controls the text conversion section 119 to drive the well-known text recognition program stored in the memory 114, so that thereby the control section 111 starts a text data conversion for the obtained image. In step 219, the converted text data is displayed on the display section 116 so as to be checked by a user. At this time, the user checks the displayed text data. If there is an error in text data, the user can modify the text data by using the key input section 115. Next, the control section 111 temporarily stores data, which reflect modification contents inputted from the user in the converted text data, in the memory 114, and step 221 is performed.

In step 221, the control section 111 classifies private information text data according to the items of the address book table. Herein, the private information text data represent text data corresponding to private information from among the text data converted from the photographed image.

The business card includes a telephone number field such as TEL, Tel, Phone, Telephone number, Telephone, and T; cell phone field such as C.P., CP, C.P, HHP, H.P, Mobile, MOBILE, and cell phone; and an e-mail address field such as E-mail, Email, e-mail, and @. In the embodiment of the present invention, an item classification can be performed by a method of automatically recognizing characteristic characters which can be commonly applied, as described above. The characteristic characters can be a telephone number identifier, “-” (e.g. 031-123-4567), a carrier identification number such as 016 and 011, or an area code such as 02 and 031, besides the telephone number field, the cell phone field, and the e-mail address field. The characteristic characters capable of being commonly recognized are stored in an item database in advance as item text data. The control section 111 compares the item text data stored in the item database with recognized item text data. From the result of the comparison, when the stored item text data is coincide with the recognized item text data, the control section 111 classifies the item text data into a corresponding item. Herein, the recognized item text data mean text data corresponding to the characteristic characters designating the items as described above from among the text data converted from the photographed image. Further, the item text data may be simultaneously a part of the private information text data. For instance, an area code 031 included in a telephone number 031-123-4567 is an item and simultaneously a part of private information.

The display and the modification are performed in the above-mentioned step 217, but the display and the modification step can be added after step 221 is performed. That is, classified text rows are displayed on the display section according to items, so that the user checks the classified contents and corrects an error again if an error exists.

The item classification in step 221 is automatically performed by the control section 111 in the embodiment of the present invention, but the user can manually perform the item classification. That is, the text data converted in step 219 are displayed on the display section 116. When the modification has been completed, the user designates item of the text data desired to be registered, in step 221. In the item designation, the control section 111 may enable the display section 116 to display an item list in the address book table, and the user can view the item list and select one item from the item list by using the key input section 115. Otherwise, the item designation may be performed by means of a predetermined hot key.

Further, the present embodiment is described on an assumption that step 221 is performed after image data in one line is converted into text data in step 217. Also, the item classification may be performed after total image data is converted into text data.

The text conversion section 119 repeats operations of step 217 to step 223. Next, when the text data conversion has been completed, step 225 is performed. That is, the control section 111 examines whether or not the total image data has been converted into text data, in step 223. From the result of examination, if the conversion has not been completed yet, step 217 is performed. Accordingly, the text data conversion is repeatedly performed. Further, when the text data conversion has been completed, step 225 is performed.

In step 225, the control section 111 stores the private information text data classified according to the items in corresponding items of the address book table, and completes the address book registration.

In the present embodiment, total image data are converted into text data and the text data are classified according to the items, and then the classified text data are stored in the address book. Otherwise, according to another embodiment, as soon as the item classification for the text data in said one line is completed in step 221, the classified text data may be stored in corresponding items of the address book.

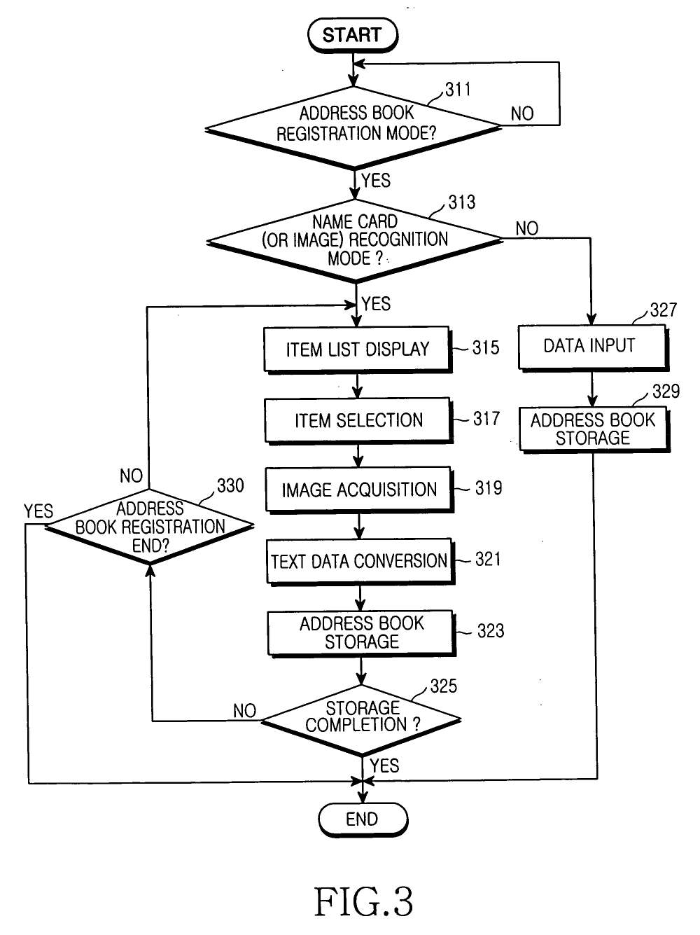

FIG. 3 is a flowchart illustrating an address book registration method according to a second exemplary embodiment of the present invention. Hereinafter, a method for registering data, which are written on a business card, in an address book according to items by means of a camera will be described in detail with reference to FIG. 3.

In step 311, the control section 111 waits an input of a function key for an address book registration and examines whether or not the function key for the address book registration of the key input section 115 has been inputted by a key operation of a user. From the result of the examination, when it is determined that the function key for the address book registration has been inputted, step 313 is performed. In step 313, the control section 111 examines whether or not a function key for a business card or an image recognition has been inputted. When it is determined that the function key for the business card recognition has been inputted in step 313, step 315 is performed. In contrast, when the function key for the business card recognition has not been inputted, step 327 is performed. In step 327, the control section 111 directly receives data from a user through the key input section 115 according to items on the basis of a typical address book registration procedure, and stores the data in the address book table according to the items in step 329.

In step 315, the control section 111 displays an item list of the address book table. In step 317, when an item requiring data input is selected from item list by the user, the control section 111 recognizes the selected item. That is, the control section 111 enables the display section 116 to display the item list of the address book table, so that the user views the displayed item list. Therefore, the user selects one item from the item list by using the key input section 115. Herein, the item list includes a name, an address, an telephone number, and an e-mail address, etc.

If the item selection has been completed, the control section 111 controls the camera section 118 and the image processing section 117 according to an operation of the user so as to obtain an image of an item of the business card which is desired to be registered in the address book table, in step 319. The analog image signal photographed by the camera section 118 is inputted to the image processing section 117. The image processing section 117 converts the analog image signal outputted from the camera section 118 into digital data by means of an analog to digital converter (ADC), and then outputs the converted data. The digital image data is compressed so as to be easily stored in the memory, and then temporarily stored in the memory 114 as temporary image data.

Herein, the image of the item which is desired to be registered in the address book table can be obtained by using various methods. First, the camera section 118 has a zoom function, and the user can photograph only a desired item on the business card by means of the zoom function. Second, the camera section 118 photographs an entire image of the business card, and only a desired item from the photographed image can be edited to be used. That is, the entire image of the photographed business card is displayed on the display section 116, and the control section 111 can control the display section 116 to select a portion, which is selected according to a key input of the user, in a box or line so as to display the selected portion. The size of the box or the length of the line can be adjusted by an operation of a key (e.g. a navigation key), which is included in the key input section 115, of the user.

After the desired image of the item is obtained, the control section 111 drives the text recognition program stored in the memory 114, and converts the image data temporarily stored in the memory 114 into text data, in step 321. The control section 111 temporarily stores the converted text data in the memory 114, and step 323 is performed. In step 323, the control section 111 stores the converted text data in an area of the item, which is selected in step 317, of the address book table, and step 325 is performed. In step 325, the control section 111 examines whether or not the address registration has been completed. From the result of the examination, when there exists an item to be registered in the address book, step 330 is performed. In step 330, the control section 111 determines whether or not the user wants to continue the address registration. For the check, a message asking user's intention can be displayed on the display section 116. In addition, methods (e.g. an output of a voice message, etc) of determining the user's intention can be variously achieved. At this time, methods (e.g. a key input or a voice input) through which the user may express his intention can be variously achieved. From the result of check in step 330, when it is determined that the user wants to continue the address registration, for instance, when an input of an address registration end command is not detected within the limited hours, step 315 is performed. That is, the address registration is repeated.

In contrast, when it is determined that the user wants to end the address registration in step 330 or the address registration has been completed in step 325, the procedure ends. For instance, cases in which it is determined that the user wants to end the address registration in step 330 are the following cases; 1) when the number of items which the user wants is smaller than the kinds of items included in the address book, 2) even though there are many items in the address book, when there is no item which the user wants.

In the present embodiment of the invention, description is given on an assumption that the examination step regarding whether or not the address registration has been completed and the examination step regarding whether or not the address registration has been ended are sequentially performed. Also, only one step of the two steps can be performed, or after changing a sequence in which the two steps are performed, the two steps can be sequentially performed according to the changed sequence.

A display and a modification can be performed after step 321 is performed, similarly to step 219 in FIG. 2. Whether or not to perform these steps is optional.

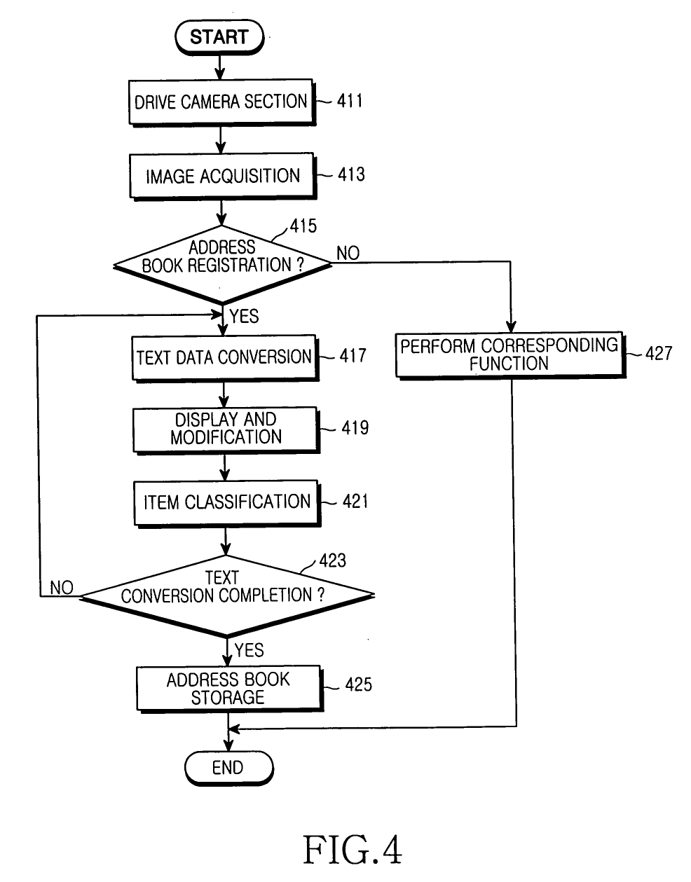

FIG. 4 is a flowchart illustrating an address book registration method according to a third exemplary embodiment of the present invention. When it is compared with the above-mentioned first embodiment in FIG. 2, the third embodiment has a difference in that an image of a business card is first obtained, and then a determination is made as to whether or not the address book registration is to be performed.

The control section 111 drives the camera section 118 in step 411, and the image of the business card is obtained in step 413. In step 415, the control section 111 examines whether or not a function key for an address book registration of the key input section 115 has been inputted by a key operation of a user. From the result of the examination, when the function key for the address book registration has not been inputted, step 427 is performed and a corresponding function (e.g. one of other well-known functions using an image photographed by a camera) is performed. In contrast, when the function key for the address book registration has been inputted in step 415, steps 417 to 425 are performed. The performance of these steps are the same as that of the above-mentioned steps 217 to 225 in FIG. 2.

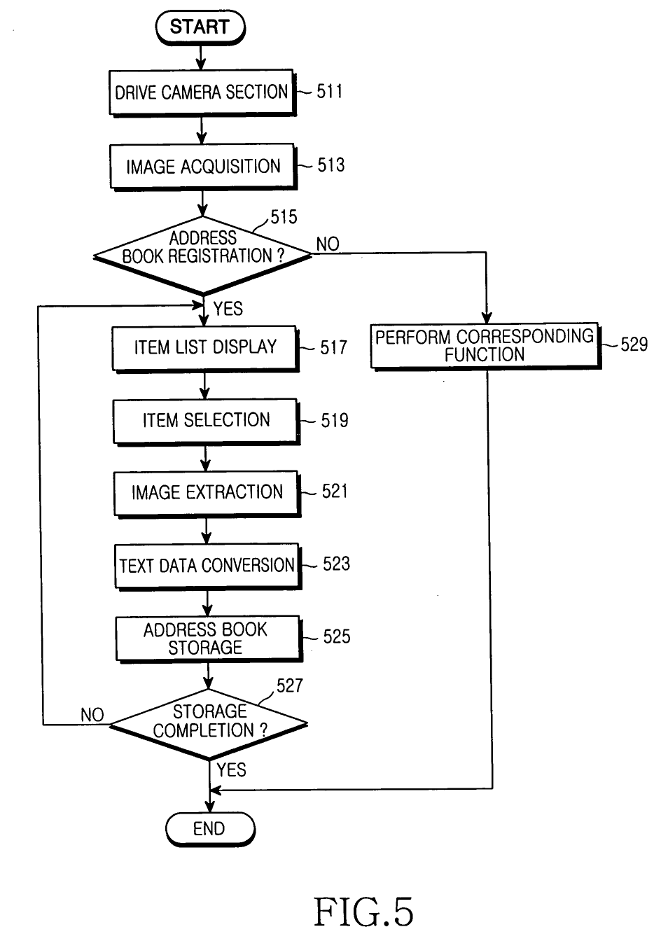

FIG. 5 is a flowchart for explaining a business card reading and storage method according to a fourth exemplary embodiment of the present invention. In comparison with the above-mentioned second embodiment in FIG. 3, the fourth embodiment has a difference in that an image of a business card is first obtained, and then a determination is made as to whether or not the address book registration is to be performed.

The control section 111 drives the camera section 118 according to an operation of a user in step 511, and controls the image processing section 117 to obtain the image of the business card in step 513. In step 515, the control section 111 examines whether or not a function key for an address book registration of the key input section 115 has been inputted by a key operation of a user. From the result of the examination, when the function key for the address book registration has not been inputted, step 529 is performed and a corresponding function (e.g. one of other well-known functions using an image photographed by a camera) is performed. In contrast, when the function key for the address book registration has been inputted in step 515, step 517 is performed. The control section 111 controls the display section 116 to display an item list in step 517. In step 519, when an item requiring an input of data is selected from among the items of the address book table by the user, the control section 111 recognizes the selected item.

If the item selection has been completed, in step 521, the control section 111 extracts an image, which corresponds to the selected item, from the image obtained in step 513. After the desired image of the item is obtained, the control section 111 drives the text recognition program stored in the memory 114, and converts image data temporarily stored in the memory 114 into text data, in step 523. The control section 111 temporarily stores the converted text data in the memory 114, and step 525 is performed. In step 525, the control section 111 stores the converted text data in an area of the item, which is selected in step 519, of the address book table, and step 527 is performed. In step 527, the control section 111 examines whether or not the address registration has been completed. From the result of the examination, when the address registration has not been completed, step 517 is performed and the address registration is performed. In contrast, when the address registration has been completed, the procedure is ended.

FIG. 5 does not show a step of determining whether or not the address registration is ended, which is similar to step 330 in FIG. 3. However, the present invention may include such a step. That is, such a step is optional.

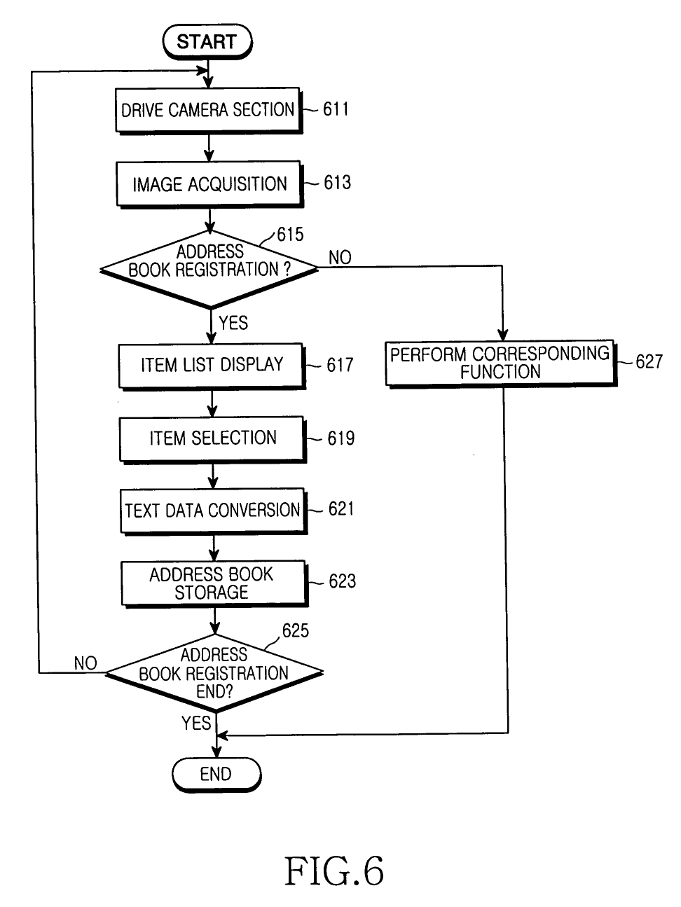

FIG. 6 is a flowchart for explaining a business card reading and storage method according to a fifth exemplary embodiment of the present invention. In comparison with the above-mentioned fourth embodiment in FIG. 5, the fifth embodiment has an identification in that an image is first obtained, and then a determination is made as to whether or not the address book registration is to be performed. However, the fifth embodiment has a difference in that the obtained image is not an image corresponding to an entire business card [the word “entire” means all private information except for a part (e.g. a log) not related to an address book], or two or more items. That is, the obtained image is an image corresponding to only one item.

The control section 111 drives the camera section 118 in step 611, and the image of the business card is obtained in step 613. It is assumed that a user photographs desired private information (e.g. a cell phone number) of an item by using a camera. As described in step 319 in FIG. 3, there exist various methods of obtaining the image by photographing desired private information of the item in this way.

After the image is obtained, in step 615, the control section 111 examines whether or not a function key for an address book registration of the key input section 115 has been inputted by a key operation of a user. From the result of the examination, when the function key for the address book registration has not been inputted, step 627 is performed and a corresponding function (e.g. one of other well-known functions using an image photographed by a camera) is performed. In contrast, when the function key for the address book registration has been inputted in step 615, step 617 is performed. The control section 111 displays an item list of the address book table in step 617. In step 619, when an item requiring an input of data is selected from the item list by the user, the control section 111 recognizes the selected item. That is, the control section 111 enables the display section 116 to display the item list of the address book table, so that the user views the displayed item list. Therefore, the user selects one item from the item list by using the key input section 115. Herein, the item list includes a name, an address, a cell phone number, and an e-mail address, etc. At this time, the user selects the item (according to the assumption, the cell phone number) corresponding to the image photographed in step 613.

If the item selection has been completed, the control section 111 drives the text recognition program stored in the memory 114, and converts image data temporarily stored in the memory 114 into text data, in step 621. The control section 111 temporarily stores the converted text data in the memory 114, and step 623 is performed. In step 623, the control section 111 stores the converted text data in an area of the item, which is selected in step 619, of the address book table, and step 625 is performed. In step 625, the control section 111 determines whether or not the user wants to continue the address registration. This check can be variously achieved similarly to the above-mentioned step 330 in FIG. 3.

From the result of check in step 625, when it is determined that the user wants to continue the address registration, step 611 is performed and a procedure waits until the user photographs the next image by using the camera.

According to the present invention as described above, private information can be conveniently stored in the address book of the portable terminal while minimizing a key input of a user. Further, according to the present invention, without installing a separate apparatus, private information written on a business card, etc., can be easily collected and registered in the address book by using a camera attached to the portable terminal. Furthermore, the business card can be easily managed.

While the invention has been shown and described with reference to certain exemplary embodiments thereof, it will be understood by those skilled in the art that various changes in form and details may be made therein without departing from the spirit and scope of the invention as defined by the appended claims.

1. An apparatus comprising:
an address book contained in a portable terminal, the address book adapted to store private information classified into one or more items;
a camera section adapted to photograph a text and to output a text image data corresponding thereto;
an image processing section adapted to convert the text image data into digital image data;
a text conversion section adapted to convert the digital image data into text data with a text recognition program; and
a control section adapted to store private information text data of the converted text data in a corresponding item of the address book, when the address book includes one item coinciding with an item of the private information text data.

2. The apparatus as claimed in claim 1, the control section further adapted to search the private information from the address book to enable a user of the portable terminal to communicate with a corresponding individual having the private information.

3. The apparatus as claimed in claim 1, further comprising a memory adapted to store the text recognition program, the memory having an area adapted to store a text database used in the text recognition program, an area for storing an item database, an area for storing the address book, and an area for temporarily storing text image data and text data recognized from text image data.

4. The apparatus as claimed in claim 1, further comprising a key input section having a function key adapted to set an image recognition mode using the camera section.

5. The apparatus as claimed in claim 2, further comprising a memory adapted to store the text recognition program, the memory having an area adapted to store a text database used in the text recognition program, an area for storing an item database, an area for storing the address book, and an area for temporarily storing the text image data and text data recognized from the text image data.

6. The apparatus as claimed in claim 2, further comprising a key input section having a function key adapted to set an image recognition mode using the camera section.

7. A method for managing an address book contained in a portable terminal, the method comprising:
arranging a camera and the address book in the portable terminal, the address book adapted to store private information classified into one or more items;
commanding the camera to obtain an image including at least one line of text;
determining whether or not the portable terminal is in an image recognition address book registration mode;
converting the obtained image into text data and repeatedly classifying the text data according to items until a text data conversion for all lines has been completed, when the portable terminal is in the image recognition address book registration mode; and
storing the text data classified according to the items in the address book.

8. The method as claimed in claim 7, further comprising searching the private information from the address book to enable a user of the portable terminal to communicate with a corresponding individual having the private information.

9. A method of managing an address book contained in a portable terminal, the method comprising:
arranging a camera and the address book in the portable terminal, the address book adapted to store private information classified into one or more items;
commanding the camera to obtain an image including at least one line of text;
determining whether or not the portable terminal is in an image recognition address book registration mode after the image has been obtained;
selecting an item when the portable terminal is in the image recognition address book registration mode;
obtaining an image corresponding to the selected item; and
converting the obtained image into text data and storing the converted text data in the address book.

10. The method as claimed in claim 9, further comprising searching the private information from the address book to enable a user of the portable terminal to communicate with a corresponding individual having the private information

11. The method as claimed in claim 7, wherein classifying text data according to items comprises:
comparing item text data stored in a database in advance with item text data of the converted text data to recognize an item; and
classifying private information text data corresponding to item text data coinciding with the item text data stored in advance into the recongnized item;
wherein the item text data corresponds to data for one text from among many predetermined characteristic texts that can be commonly recognized as one item.

12. The method as claimed in claim 7, wherein classifying text data according to items comprises: displaying the converted text data; and classifying the text data into items selected by a user to store classified data.

13. The method as claimed in claim 7, wherein storing the text data classified according to the items in the address book is performed after a text data conversion for all of the lines has been completed.

14. The method as claimed in claim 7, wherein storing the text data classified according to the items in the address book is performed after a text data conversion for one line has been completed.

15. A method for managing an address book contained in a portable terminal, the method comprising:
arranging a camera and the address book, the address book storing private information classified into one or more items in the address book;
commanding the camera to obtain an image from a medium including text;
determining whether or not the portable terminal is in an image recognition address book registration mode;
selecting an item when the portable terminal is in the image recognition address book registration mode; and
converting the obtained image into text data and storing the converted text data corresponding to the selected item in the address book.

16. The method as claimed in claim 15, further comprising searching the private information from the address book to enable a user of the portable terminal to communicate with a corresponding individual having the private information.

17. The method as claimed in claim 15, further comprising determining whether or not the address book registration has been terminated, waiting until a next image is obtained if an input meaning user's intention not to terminate the address book registration has been detected, otherwise ending a procedure.

18. The method as claimed in claim 16, further comprising determining whether or not the address book registration has been terminated, waiting until a next image is obtained if an input meaning user's intention not to terminate the address book registration has been detected, otherwise ending a procedure.

19. The method as claimed in claim 7, further comprising displaying the converted text data on a display section and modifying the converted text data according to modification data inputted by a user after the converted text data has been displayed.

20. The method as claimed in claim 9, further comprising displaying the converted text data on a display section and modifying the converted text data according to modification data inputted by a user after the converted text data has been displayed.

21. The method as claimed in claim 15, further comprising displaying the converted text data on a display section and modifying the converted text data according to modification data inputted by a user after the converted text data has been displayed.

22. The method as claimed in claim 7, wherein the selected item coincides with one of said one or more items of the address book.

23. The method as claimed in claim 9, wherein the selected item coincides with one of said one or more items of the address book.

24. The method as claimed in claim 15, wherein the selected item coincides with one of said one or more items of the address book.

25. The method as claimed in claim 9, wherein selecting an item comprises displaying an item list of an address book table on a display section and detecting an item if a user selects the item in the displayed item list.

26. The method as claimed in claim 15, wherein selecting an item comprises displaying an item list of an address book table on a display section and detecting an item if a user selects the item in the displayed item list.

27. The method as claimed in claim 9, further comprising determining whether or not storage of all of the items has been completed and returning to selecting an item if the storage of all of the items has not yet been completed.

28. The method as claimed in claim 15, further comprising determining whether or not storage of all of the items has been completed and returning to selecting an item if the storage of all of the items has not yet been completed.
